(19) United States
(12) Patent Application Publication
(10) Pub. No.: US 2019/0310705 A1
(43) Pub. Date: Oct. 10, 2019

(54) IMAGE PROCESSING METHOD, HEAD MOUNT DISPLAY, AND READABLE STORAGE MEDIUM

(71) Applicant: Lenovo (Beijing) Co., Ltd., Beijing (CN)

(72) Inventor: Juan David HINCAPIE RAMOS, Beijing (CN)

(21) Appl. No.: 16/374,930

(22) Filed: Apr. 4, 2019

(30) Foreign Application Priority Data
Apr. 4, 2018 (CN) 201810300196.4

(51) Int. Cl. G06F 3/01; H04N 13/128; H04N 13/332; G06T 19/00; G02B 27/01

(52) U.S. Cl. CPC G06F 3/013; H04N 13/128; H04N 2013/0081; G06T 19/006; G02B 27/0179; H04N 13/332

(57) ABSTRACT

An image processing method for a head mount display is provided. The image processing method comprises obtaining a first rendering pitch corresponding to a user's real interpupillary distance; and adjusting, according to the first rendering pitch, display positions of two rendering images to be rendered by two physical displays of the head mount display, such that the rendering images respectively rendered by the two physical displays correspond to the user's real interpupillary distance.

### CROSS-REFERENCES TO RELATED APPLICATIONS

This application claims priority of Chinese Patent Application No. 201810300196.4, filed on Apr. 4, 2018, the entire contents of which are hereby incorporated by reference.

### FIELD OF THE INVENTION

The present disclosure generally relates to the field of image processing technologies and, more particularly, relates to an image processing method, a head mount display and a readable storage medium.

### BACKGROUND

Currently, a head mount display (HMD) can achieve augmented reality (AR) effects by transmitting optical signals to the eyes of a user. Augmented reality technology combines virtual objects with a real environment to enhance the user's perception of the real environment.

Head mount displays can be used in many applications, such as military applications, monument restorations, digital cultural heritage protection applications, medical applications, industrial maintenance applications, and the like. The application areas require the depth of a virtual object that a user perceives in the real environment to be accurate. Otherwise the user cannot perform correct operations in the applications.

How to improve the accuracy of the depth of a virtual object perceived by a user when the user carries a head mount display is a technical problem that those skilled in the art need to study. The disclosed methods and systems are directed to solve one or more problems set forth above and other problems.

### BRIEF SUMMARY OF THE DISCLOSURE

One aspect of the present disclosure provides an image processing method for a head mount display. The image processing method comprises obtaining a first rendering pitch corresponding to a user's real pupillary distance; and adjusting, according to the first rendering pitch, display positions of two rendering images to be rendered by two physical displays of the head mount display, such that the rendering images respectively rendered by the two physical displays correspond to the user's real interpupillary distance.

Another aspect of the present disclosure provides a head mount display. The head mount display comprises a memory for storing computer programs and a processor coupled to the memory for executing the computer programs. The processor performs: obtaining a first rendering pitch corresponding to a user's real interpupillary distance; and adjusting, according to the first rendering pitch, display positions of two rendering images to be rendered by two physical displays of the head mount display, such that the rendering images respectively rendered by the two physical displays correspond to the user's real interpupillary distance.

Another aspect of the present disclosure provides a non-transitory computer-readable storage medium containing computer-executable instructions. When executed by one or more processors, the computer-executable instructions perform an image processing method for a head mount display. The method comprises obtaining a first rendering pitch corresponding to a user's real interpupillary distance; and adjusting, according to the first rendering pitch, display positions of two rendering images to be rendered by two physical displays of the head mount display, such that the rendering images respectively rendered by the two physical displays correspond to the user's real interpupillary distance.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions of this disclosure, the accompanying drawings will be briefly introduced below. Obviously, the drawings are only part of the disclosed embodiments. Those skilled in the art can derive other drawings from the disclosed drawings without creative efforts.

FIG. 1 illustrates a schematic diagram of an implementation principle of a head mount display;

FIGS. 2A-2C illustrate schematic diagrams of the relationship between a device IPD and a rendering IPD and a user IPD consistent with the disclosed embodiments;

FIG. 3 illustrates a flowchart of an implementation of an image processing method consistent with the disclosed embodiments;

FIGS. 4A-4B illustrate schematic diagrams showing the difference between before and after rendering images by two physical displays consistent with the disclosed embodiments;

FIG. 5 illustrates a flowchart of an implementation of acquiring a first rendering pitch in an image processing method consistent with the disclosed embodiments;

FIGS. 6A-6C illustrate schematic diagrams of adjusting the positional relationship between a virtual object and a preset entity identifier consistent with the disclosed embodiments;

FIGS. 7A-7C illustrate schematic diagrams of an image to be rendered moving in a visible area consistent with the disclosed embodiments;

FIGS. 8A-8B illustrate schematic diagrams before and after moving of a rendering image after the size of the rendering image is increased consistent with the disclosed embodiments;

FIG. 9 illustrates a structural diagram of an implementation of a head mount display consistent with the disclosed embodiments; and

FIG. 10 illustrates a structural diagram of another implementation of a head mount display consistent with the disclosed embodiments.

### DETAILED DESCRIPTION

The technical solutions in the embodiments of the present disclosure are clearly and completely described in the following with reference to the accompanying drawings in the embodiments of the present invention. It is obvious that the described embodiments are only part not all of the embodiments of the present disclosure. All other embodiments obtained by those skilled in the art according to the embodiments of the present disclosure without creative efforts are within the scope of the present disclosure.

At present, there are various types of head mount displays, such as a video-perspective head mount display, an optical perspective head mount display, and the like. The implementation principle of a video perspective head mount display is taken as an example to explain the existing problems.

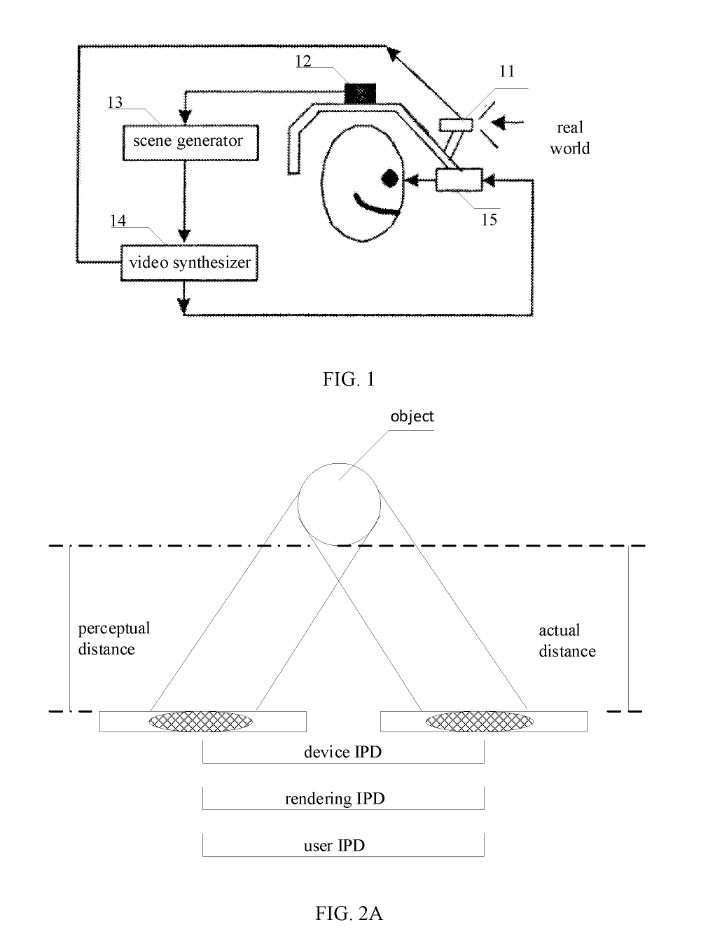

FIG. 1 illustrates a schematic diagram of an implementation principle of a head mount display. As shown in FIG. 1, a head mount display 10 may include a camera 11, a head tracker 12, a scene generator 13, a video synthesizer 14, and two physical displays 15.

The camera 11 is provided for capturing images in the real world. The head tracker 12 is provided for positioning a user's head. The scene generator 13 is provided for generating an image of the corresponding virtual scene based on the positioning of the head tracker. The synthesizer 14 is provided for synthesizing images of a virtual scene and images in a real world. Two physical displays 15 are provided for displaying synthesized images. Accordingly, a user can view images of a real world and a virtual scene merged through the two physical displays 15.

When the user observes images displayed in the two physical displays 15, according to the stereoscopic vision, the user may know the distance, depth, and concave/convex between the observed object and the surrounding object. Stereoscopic vision refers to a user's two eyes gazing at an object at the same time. The two eyes are crossed to a point of the object, which is called the gaze point. The light spot reflected from the gaze point back to the retina corresponds to the gaze point. The two point signals are transferred to the brain vision center to synthesize a complete image of the object, which not only makes the person see the object clearly, but also the distance, depth, concave/convex and the like between the object and the surrounding object can be discerned. The formed image described above is a stereoscopic image and the vision described above is called stereoscopic vision.

A head mount display has two physical displays, and the physical distance between the two physical displays (i.e., a device IPD) is equivalent to a user IPD (a user's real pupillary distance is referred to as a user IPD in the embodiments). The two physical displays mimic the way the human eye sees an object, allowing a user to perceive the position of the object through the rendering image presented by the two physical displays. However, viewing the rendering image through the head mount display is different from the user directly viewing the real world image with the eyes, because the user directly looks at the real world with the eyes only involves the user IPD between the user's eyes. While the image viewed by the user through the physical displays of the head mount display involves the user IPD, the device IPD between the two physical displays 15, and the rendering IPD between the images presented by the two physical displays 15.

If a device IPD and a rendering IPD of a head mount display are different from a user IPD, the user perceives that the position of an observed object does not match the actual position. The following example illustrates the impact of difference between the device IPD on a head mount display, the rendering IPD, and the user IPD.

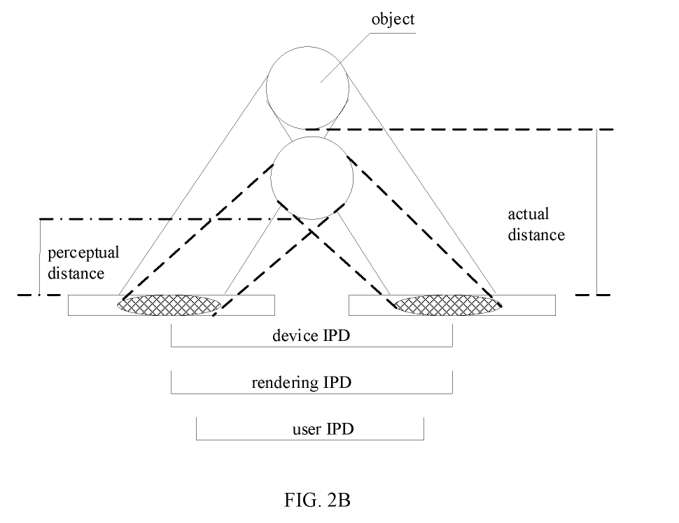

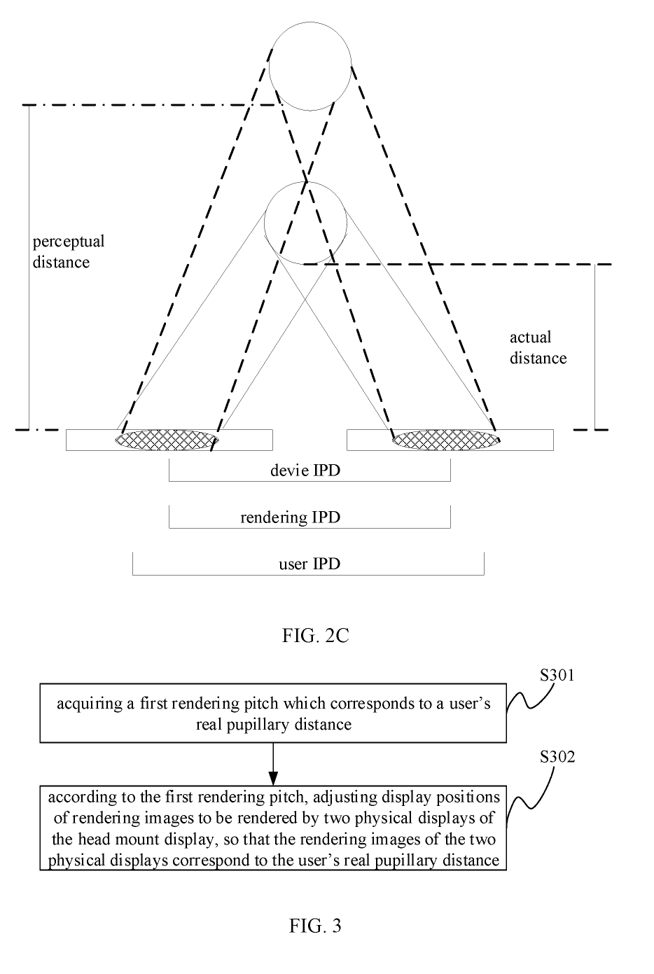

In one embodiment, the relationships between a device IPD, a rendering IPD and a user IPD are shown in FIG. 2A to FIG. 2C.

As shown in FIG. 2A, the device IPD and the rendering IPD are the same as the user IPD, so the distance perceived by a user is the same as the actual distance.

FIG. 2B shows that the device IPD and the rendering IPD are larger than the user IPD, so the distance of a virtual object perceived by the user is closer than the actual distance.

As shown in FIG. 2C, if the device IPD and the rendering IPD are smaller than the user IPD, the distance of a virtual object perceived by the user is farther than the actual distance.

A head mount display adopts an augmented reality (AR) technology, and the head mount display can be applied to many application scenarios, such as device maintenance application scenarios, healthcare applications, and the like. If the position of an object perceived by a user does not match the true position of the object, it will have a serious impact. For example, in the field of device maintenance, when a user wears a head mount display, virtual objects can be seen. If the user's head carries a head mount display to repair the vehicle, and the user can observe components to be eliminated indicated by the virtual objects in the vehicle existing in the real world. If the distances of the virtual objects perceived by the user do not match the actual ones, it may be wrong to remove other components.

When a user carries a head mount display, a device IPD and a rendering IPD need to be adjusted so that the device IPD and the rendered IPD are the same as a user IPD. The following describes the process of adjusting the rendering IPD of a head mount display in one embodiment.

FIG. 3 illustrates a flowchart of an implementation of an image processing method consistent with the disclosed embodiments. As shown in FIG. 3, the image processing method includes the followings.

S301: acquiring a first rendering pitch which corresponds to a user's real interpupillary distance (IPD).

A head mount display has an original rendering pitch before a user adjusts the rendering pitch of the head mount display (the rendering pitch may be referred as the rendering IPD) such as preset rendering pitch or default rendering pitch. After the user carries the head mount display, the head mount display can be adjusted on the original rendering pitch, such that the original rendering pitch of the head mount display becomes a first rendering pitch after the adjustment.

S302: according to the first rendering pitch, adjusting display positions of rendering images to be rendered by two physical displays of the head mount display, such that the rendering images of the two physical displays correspond to the user's real interpupillary distance.

In one embodiment, display positions of rendering images displayed by the two physical displays may be adjusted according to the first rendering pitch without changing the device IPD, such that the center distance of the rendering images displayed by the two physical displays correspond to the user's real interpupillary distance (i.e., the user IPD). This method is equivalent to adjusting the device IPD.

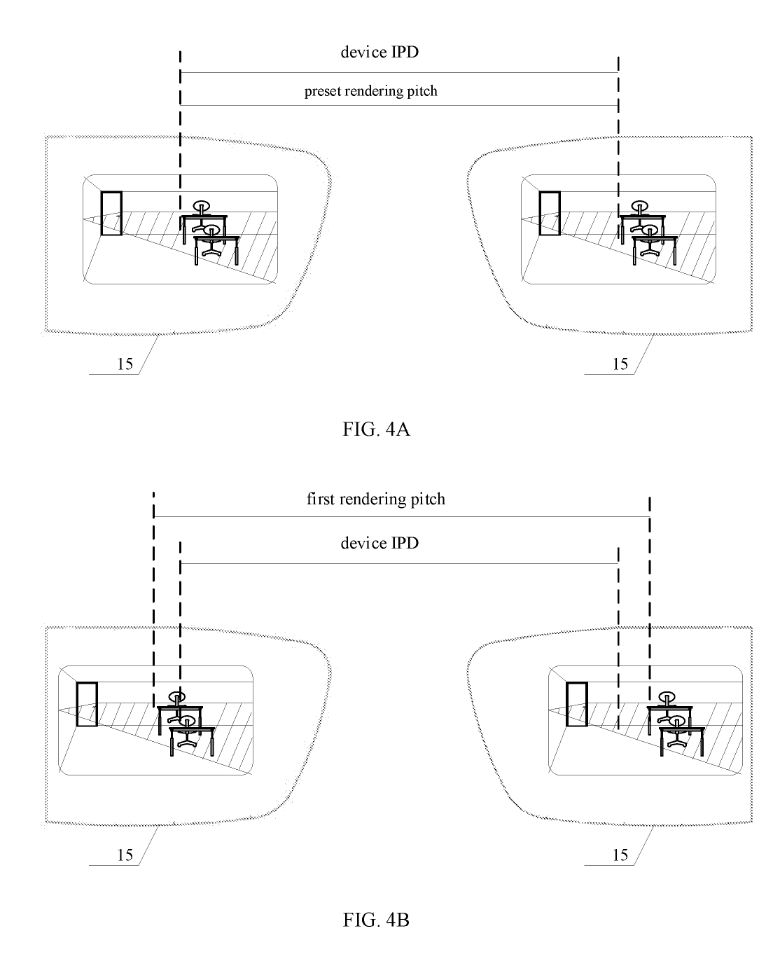

Schematic diagrams showing difference between before and after rendering images by two physical displays renderings consistent with the disclosed embodiments are shown in FIG. 4A to FIG. 4B. FIG. 4A to FIG. 4B are examples in which a user IPD is larger than a device IPD and a rendering IPD.

FIG. 4A shows rendering images displayed on the two physical displays 15 before the rendering pitch adjustment (i.e., the original rendering pitch) of the head mount display. The rendering pitch between the two rendering images is the same as the device IPD.

FIG. 4B shows rendering images displayed on the two physical displays 15 after the rendering pitch adjustment (i.e., the first rendering pitch) of the head mount display. It can be seen that the two rendering images are far apart from each other.

According to the present disclosure, the display device does not adjust the device IPD of a head mount display by adding additional hardware, such as sensors, cameras, displays, 3D cameras, and the like. Instead, by adjusting display positions of rendering images displayed on the two physical displays, which is equivalent to adjusting the device IPD, the cost of the head mount display is saved and the size of the head mount display is reduced.

The image processing method provided by the present disclosure acquires a first rendering pitch, which corresponds to a user's real interpupillary distance. According to the first rendering pitch, display positions of rendering images to be rendered by two physical displays of the head mount display are adjusted, such that the rendering images respectively rendered by the two physical displays correspond to the user's real interpupillary distance. The embodiments of the present disclosure intelligently adopts a method of adjusting display positions of rendering images to be rendered by two physical displays according to the first rendering pitch, which is equivalent to adjusting the device IPD of the head mount display. There is no need to install an additional device in a head mount display that requires changing the device IPD of the head mount display, such as sensors, cameras, displays, 3D cameras, and the like, such that the cost is saved and the size of the head mount display is reduced because of no need to install an additional device

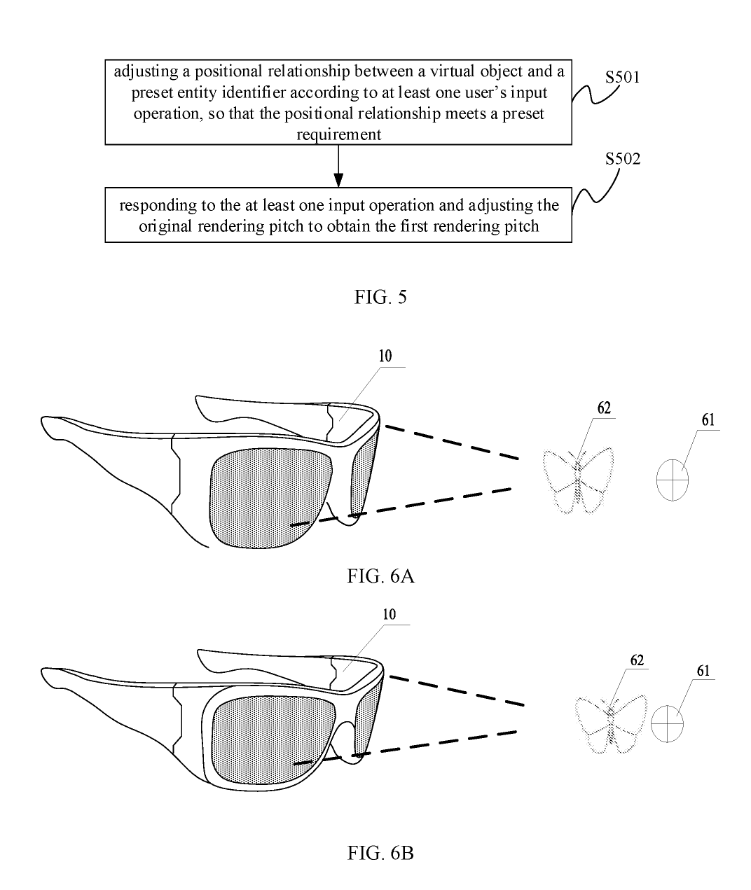

FIG. 5 illustrates a flowchart of an implementation of acquiring a first rendering pitch in an image processing method consistent with the disclosed embodiments. As shown in FIG. 5, the image processing method includes the followings.

Step S501: adjusting a positional relationship between a virtual object and a preset entity identifier according to at least one user's input operation, such that the positional relationship meets a preset requirement.

In one embodiment, the input operation may be a preset gesture operation, and/or a mouse click operation, and/or a preset touch operation. In one embodiment, a plurality of input operations may be required to adjust the original rendering pitch of a head mount display to the first rendering pitch. The original rendering pitch can be adjusted in turn based on the input time sequence of the input operations.

S502: responding to the at least one input operation and adjusting the original rendering pitch to obtain the first rendering pitch.

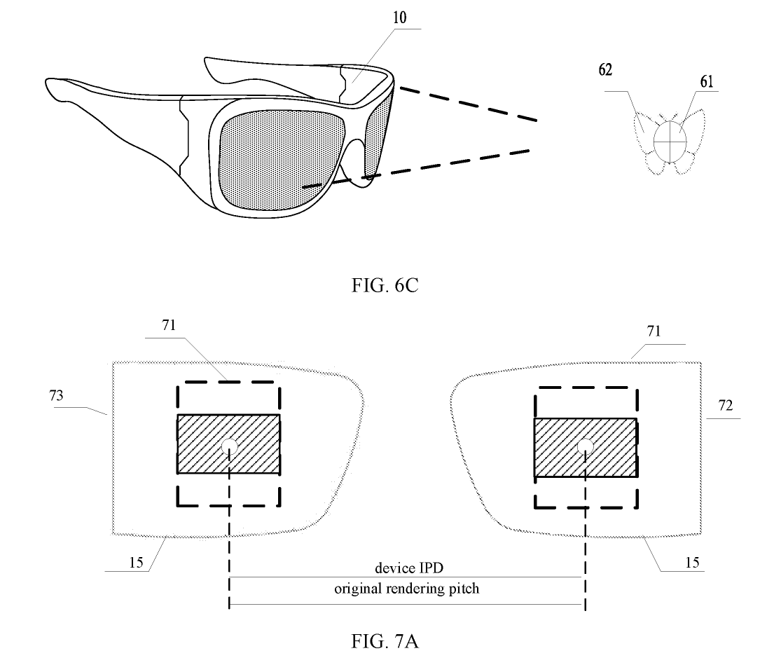

FIG. 6A to FIG. 6C illustrate schematic diagrams of adjusting a positional relationship between a virtual object and a preset entity identifier consistent with the disclosed embodiments.

After the user carries the head mount display, a preset entity identifier 61 and a virtual object 62 can be observed. In one embodiment, if a user IPD is the same as a device IPD and a rendering IPD, a virtual object should override the preset entity identifier. If the user IPD is different from the device IPD and the rendering IPD, the virtual object does not overwrite the preset entity identifier.

As shown in FIG. 6A, based on the positional relationship between the virtual object 62 and the preset entity identifier 61 that are first viewed after the user carries the head mount display, the virtual object 62 does not cover the preset entity identifier 61.

Since the virtual object 62 does not cover the preset entity identifier 61, an input operation is required, and the original rendering pitch is adjusted in response to the input operation. The adjusted result is shown in FIG. 6B.

As shown in FIG. 6B, the position of the virtual object 62 and the position of preset entity identifier 61 are already very close, but the virtual object 62 does not cover the preset entity identifier 61. It is necessary to continue the adjustment, performing an input operation again, and responding to the input operation. The current rendering pitch corresponding to FIG. 6B is adjusted, and the adjusted result is as shown in FIG. 6C.

As shown in FIG. 6C, the virtual object 62 has been overlaid on the preset entity identifier 61. Accordingly, the rendering pitch corresponding to FIG. 6C is referred to as a first rendering pitch.

In one embodiment, both physical displays of the head mount display 10 have a viewable area for presenting rendering images to a user. In one embodiment, the device IPD is center spacing of the visible areas of the two physical displays. In the embodiments of the present invention, the method for adjusting the display positions of rendering images to be rendered by the two physical displays of the head mount display according to the first rendering pitch includes: according to the first rendering pitch, respectively moving the two rendering images to be rendered in the respective visible areas, such that the center positions of the two rendering images to be rendered correspond to the user's real interpupillary distance.

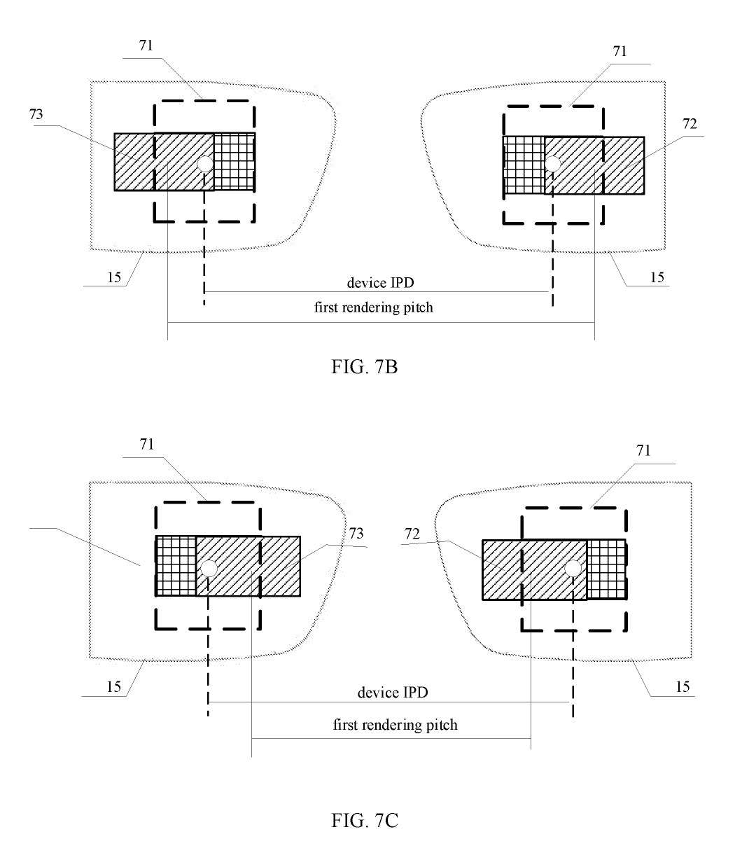

FIG. 7A to FIG. 7C illustrate schematic diagrams of an image to be rendered moving in a visible area consistent with the disclosed embodiments. As shown in FIG. 7A, when the display position of the rendering image to be rendered in the two physical displays is not adjusted, the rendering image is located in the visible area.

The area framed by dashed lines in FIG. 7A to FIG. 7C is the viewable area 71. The distance between the centers of the two viewable areas in FIG. 7A (marked by circles in FIG. 7a) is the device IPD. The center distance between the two rendering images is the original rendering pitch. In general, the original rendering pitch is the same as the original device IPD.

The display position before the rendering image 72 and the rendering image 73 are adjusted is shown in FIG. 7A.

If the user IPD, that is, the real interpupillary distance is greater than the device IPD and the rendering IPD, that is, the first rendering pitch is greater than the original rendering pitch. The rendered image 72 moves to the right, and the corresponding rendered image 73 moves to the left. That is, the distance between the two rendered images becomes larger.

As shown in FIG. 7B, in order to show the difference between before and after the two rendering images are moved, the cuboid filled with a mesh shows that the position of the rendering image before the movement, and the cuboid filled with diagonal lines shows the position of the rendering image after the movement. The center spacing of the moved rendered image 72 and the moved rendered image 73 is the first rendering pitch.

If the user IPD is smaller than the device IPD and the rendered IPD, that is, the first rendering pitch is smaller than the original rendering pitch. The rendering image 72 moves to the left, and the corresponding rendering image 71 moves to the right, that is, the distance between the two rendered images becomes smaller.

As shown in FIG. 7C, to show the difference between before and after the two rendering images are moved, the cuboid filled with a mesh shows that the position of the rendering image before the movement and the cuboid filled with diagonal lines shows the position of the rendering image after the movement. The center spacing of the moved rendering image 72 and the moved rendering image 73 is the first rendering pitch.

In one embodiment, the image displayed in the visible area can be observed by a user, while the image outside the viewable area cannot be observed by the user. Since the size of the rendered rendering image is certain, and part of the rendering image has been removed out of the visible area, the user cannot observe the partial image out of the visible area. That is, a local area in the visible area (i.e., the cuboids filled with a mesh shown in FIG. 7B or FIG. 7C) cannot display the rendering image. In one embodiment, the local area in the visible area where the rendering image cannot be displayed is referred to as a first area.

In one embodiment, the foregoing image processing method may further include: after determining that the two rendering images to be rendered are respectively moved in the corresponding visible areas, the two visible areas respectively correspond to the first areas that cannot display the rendering images; displaying the rendering images in the first areas corresponding to the two visible areas according to the preset display manner.

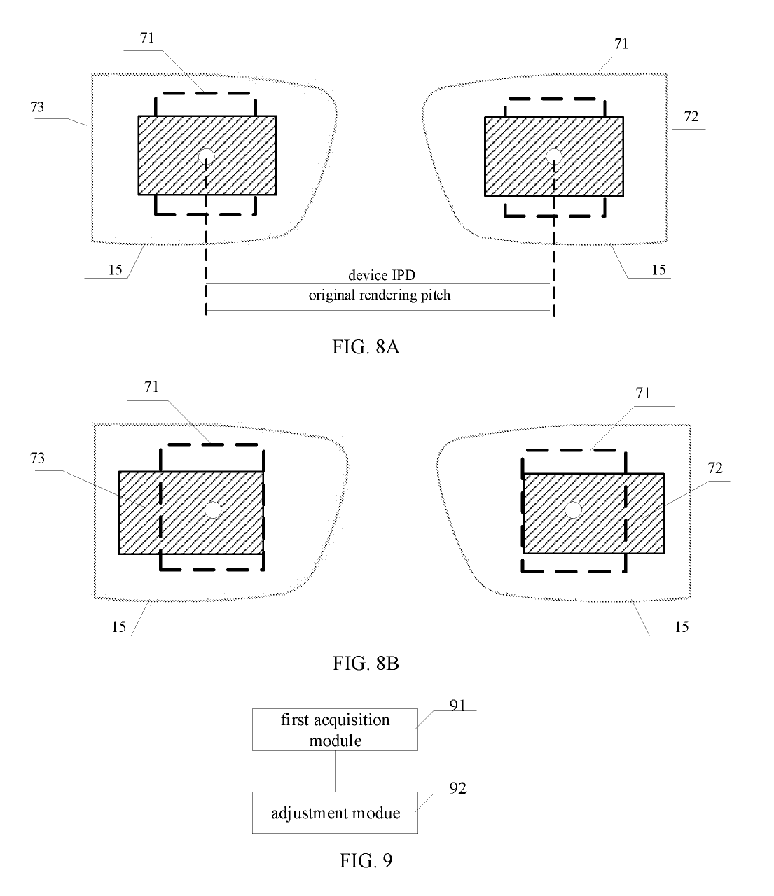

In one embodiment, the size of a rendering image may be increased. FIG. 8A to FIG. 8B illustrate schematic diagrams of before and after moving a rendering image after the size of the rendering image is increased consistent with the disclosed embodiments. The size of the rendering image is larger than the size of the visible area. Even if the display position of the rendering image to be rendered of the two physical displays changes, the visible area does not appear to be unable to display the first area of the rendering image due to the change of the display position of the rendering image. In this embodiment, the preset display manner is to respectively display corresponding partial rendering images in two visible areas.

In one embodiment, the preset display manner may be: displaying a corresponding image of displaying the real world, or displaying a preset image.

In one embodiment, the rendering image displayed in the visible area can be observed by a user, and the rendering image beyond the visible area cannot be observed by the user. Since the size of the rendered rendering picture is certain, and the partial image of the rendering image is removed out of the visible area, the user cannot observe the partial image out of the visible area. That is, the visible area can display a partial image of the rendering image. In one embodiment, the area where the partial image of the rendering image is displayed in the visible area is referred to as an actual output display area. The method may further include: determining, after the two rendering images to be rendered are respectively moved in the corresponding visible areas, the actual output display areas corresponding to two visible regions respectively that display rendering images; performing rendering operations respectively in the actual output display area of the corresponding visible area according to rendering images to be rendered.

FIG. 9 illustrates a structural diagram of an implementation of a head mount display consistent with the disclosed embodiments. As shown in FIG. 9, the head mount display includes: a first acquisition module 91 for acquiring a first rendering pitch, which corresponds to a user's real interpupillary distance; and an adjusting module 92 for adjusting, according to the first rendering pitch, a display position of the rendering image to be rendered by two physical displays of the head mount display, such that the rendering image rendered respectively by the two physical displays correspond to the user's real interpupillary distance.

In one embodiment, the first acquisition module includes: a first adjustment unit for adjusting a positional relationship between a virtual object and a preset entity identifier according to the at least one user's input operation, such that the positional relationship meets a preset requirement; and a second adjustment unit for responding to the at least one input operation and adjusting an original rendering pitch to obtain the first rendering pitch.

In one embodiment, the second adjustment unit specifically responds to each of the at least one input operation, and adjusts the original rendering pitch according to a chronological order to obtain the first rendering pitch.

In one embodiment, each physical display includes a visible area for presenting rendering images to a user. The adjustment module comprises a moving unit, for respectively moving two rendering images to be rendered in the corresponding visible areas according to the first rendering pitch, such that the center positions of the two rendering images to be rendered corresponds to a user's real interpupillary distance.

In one embodiment, the head mount display further includes: a first determination module for determining first areas respectively corresponding to two visible areas that cannot display the rendering image; and a display module for displaying in the first areas corresponding to the two visible areas according to the preset display format.

In one embodiment, the head mount display further includes: a second determination module for determining, after the two rendering images to be rendered respectively move in the corresponding visible area, the actual output display area respectively corresponding to the two visible areas that display rendering images; and a rendering module for performing rendering operations respectively in actual output display areas of visible areas according to two rendering images to be rendered.

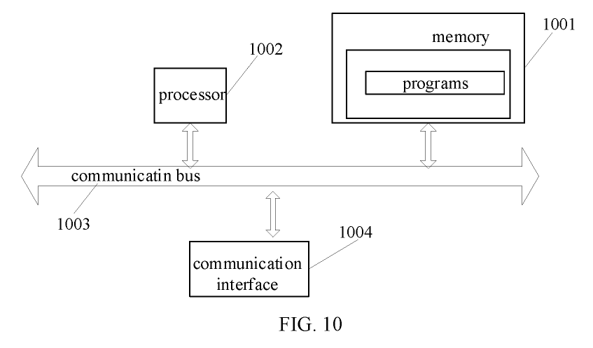

FIG. 10 is a structural diagram of another implementation of a head mount display consistent with the disclosed embodiment. As shown in FIG. 10, the head mount display includes a memory 1001 for storing a program and a processor 1002 for executing the program which is specifically provided for: obtaining a first rendering pitch, which corresponds to a user's real interpupillary distance; and an adjusting, according to the first rendering pitch, display positions of the rendering images to be rendered by the two physical displays of the head mount display, such that the rendering images respectively rendered by the two physical displays correspond to the user's real interpupillary distance.

The processor 1002 may be a central processing unit CPU, or an application specific integrated circuit (ASIC), or one or more integrated circuits for implementing one embodiments of the present disclosure.

Optionally, a first electronic device may further include a communication bus 1003 and a communication interface 1004. The memory 1001, the processor 1002, and the communication interface 1004 complete communication with each other through the communication bus 1003.

Optionally, the communication interface 1004 can be an interface of the communication module, such as an interface of a GSM module.

A readable storage medium with stored computer programs is provided in one embodiment. The computer programs are executed by a processor to implement various steps of the image processing method according to any of the above image processing methods.

The various embodiments in this specification are described in a progressive manner. Each embodiment focuses on differences from other embodiments. The same or similar parts between various embodiments can be referred to each other.

It should be understood that the disclosed devices and method provided in the disclosure may be implemented in other ways. The embodiments described above are merely illustrative. For example, the division of the unit is only a logical function division. In actual implementation, there may be other division ways such as: a plurality of units or components may be combined, or can be integrated into another system, or some features can be ignored or not executed. In addition, the coupling or communication connection of the components shown or discussed above may be indirect coupling or communication connection through some interfaces, devices or units, and may be electrical, mechanical or other forms.

The units described above as separate components may or may not be physically separated. The components displayed as the unit may or may not be physical units. That is, the units may be located in one place or distributed to a plurality of network units. Some or all of the units may be selected according to actual needs to achieve the purpose of the solution of the embodiments. In addition, each functional unit in each embodiment of the present invention may be integrated into one processing unit, or each unit may exist physically separately, or two or more units may be integrated into one unit.

The functions may be stored in a computer readable storage medium if implemented in the form of a software functional unit and sold or used as an independent product. Based on the above understanding, a prat of the technical solution of the present disclosure that contributes in essence to the prior art, or a part of the technical solution may be embodied in the form of a software product. The computer software product is stored in a storage medium and includes commands for causing a computer device which may be a personal computer, server, a network device, or the like to perform all or part of the steps of the methods of various embodiments of the present invention. The foregoing storage medium includes: a U disk, a mobile hard disk, a read-only memory (ROM), a random access memory (RAM), a magnetic disk, an optical disk, or the like, which can store program codes.

The above description of the disclosed embodiments enables those skilled in the art to make or use the invention. Various modifications to these embodiments are obvious to those skilled in the art. The general principles defined herein may be implemented in other embodiments without departing from the spirit or scope of the disclosure. The present disclosure is not intended to be limited to the embodiments shown herein, but is to be accorded the broadest scope consistent with the principles and novel features disclosed herein.

What is claimed is:

1. An image processing method for a head mount display, comprising:
obtaining a first rendering pitch corresponding to a user's real interpupillary distance; and
adjusting, according to the first rendering pitch, display positions of two rendering images to be rendered by two physical displays of the head mount display, such that the rendering images respectively rendered by the two physical displays correspond to the user's real interpupillary distance.

2. The image processing method according to claim 1, wherein obtaining the first rendering pitch comprises:
adjusting a positional relationship between a virtual object and a preset entity identifier according to at least one user input operation, such that the positional relationship meets a preset requirement; and
responding to the at least one user input operation and adjusting an original rendering pitch to obtain the first rendering pitch.

3. The image processing method according to claim 2, wherein responding to the at least one user input operation and the adjusting the original rendering pitch comprise:
responding to each of the at least one input operation to obtain the first rendering pitch and adjusting the original rendering pitch according to a chronological order.

4. The image processing method according to claim 1, wherein:
each of the physical displays includes a visible area for presenting a rendering image to the user, and adjusting, according to the first rendering pitch, the display position of the two rendering images includes:
according to the first rendering pitch, respectively moving the two rendering images to be rendered in the corresponding visible areas, such that a center position of the two rendering images to be rendered corresponds to the user's real interpupillary distance.

5. The image processing method according to claim 4, further comprising:
determining, after the two rendering images to be rendered are respectively moved in the corresponding visible regions, first areas respectively corresponding to two visible areas that cannot display the rendering images; and
displaying in the first areas corresponding to the two visible areas according to a preset display format.

6. The image processing method according to claim 5, further comprising:
determining, after that the two rendering images to be rendered respectively move in the corresponding visible areas, actual output display areas respectively corresponding to the two visible areas that display the two rendering images to be rendered; and
according to the two rendering images to be rendered, respectively performing rendering operations in the actual output display areas of visible areas.

7. A head mount display, comprising:
a memory for storing computer programs; and
a processor coupled to the memory for executing the computer programs to perform:
obtaining a first rendering pitch corresponding to a user's real interpupillary distance; and
adjusting, according to the first rendering pitch, display positions of two rendering images to be rendered by two physical displays of the head mount display, such that the rendering images respectively rendered by the two physical displays correspond to the user's real interpupillary distance.

8. The head mount display according to claim 7, wherein obtaining the first rendering pitch comprises:
adjusting a positional relationship between a virtual object and a preset entity identifier according to at least one user input operation, such that the positional relationship meets a preset requirement; and
responding to the at least one user input operation and adjusting an original rendering pitch to obtain the first rendering pitch.

9. The head mount display according to claim 8, wherein responding to the at least one user input operation and the adjusting the original rendering pitch comprise:
responding to each of the at least one input operation to obtain the first rendering pitch and adjusting the original rendering pitch according to a chronological order.

10. The head mount display according to claim 7, wherein:
each of the physical displays includes a visible area for presenting a rendering image to the user, and adjusting, according to the first rendering pitch, the display position of the two rendering images includes:
according to the first rendering pitch, respectively moving the two rendering images to be rendered in the corresponding visible areas, such that a center position of the two rendering images to be rendered corresponds to the user's real interpupillary distance.

11. The head mount display according to claim 10, wherein the processor further performs:
determining, after the two rendering images to be rendered are respectively moved in the corresponding visible regions, first areas respectively corresponding to two visible areas that cannot display the rendering images; and
displaying in the first areas corresponding to the two visible areas according to a preset display format.

12. The head mount display according to claim 11, wherein the processor further performs:
determining, after that the two rendering images to be rendered respectively move in the corresponding visible areas, actual output display areas respectively corresponding to the two visible areas that display the two rendering images to be rendered; and
according to the two rendering images to be rendered, respectively performing rendering operations in the actual output display areas of visible areas.

13. A non-transitory computer-readable storage medium containing computer-executable instructions for, when executed by one or more processors, performing an image processing method for a head mount display, the method comprising:
obtaining a first rendering pitch corresponding to a user's real interpupillary distance; and
adjusting, according to the first rendering pitch, display positions of two rendering images to be rendered by two physical displays of the head mount display, such that the rendering images respectively rendered by the two physical displays correspond to the user's real interpupillary distance.

14. The non-transitory computer-readable storage medium according to claim 13, wherein obtaining the first rendering pitch comprises:
adjusting a positional relationship between a virtual object and a preset entity identifier according to at least one user input operation, such that the positional relationship meets a preset requirement; and
responding to the at least one user input operation and adjusting an original rendering pitch to obtain the first rendering pitch.

15. The non-transitory computer-readable storage medium according to claim 14, wherein responding to the at least one user input operation and the adjusting the original rendering pitch comprise:
responding to each of the at least one input operation to obtain the first rendering pitch and adjusting the original rendering pitch according to a chronological order.

16. The non-transitory computer-readable storage medium according to claim 13, wherein:
each of the physical displays includes a visible area for presenting a rendering image to the user, and adjusting, according to the first rendering pitch, the display position of the two rendering images includes:
according to the first rendering pitch, respectively moving the two rendering images to be rendered in the corresponding visible areas, such that a center position of the two rendering images to be rendered corresponds to the user's real interpupillary distance.

17. The non-transitory computer-readable storage medium according to claim 16, the method further comprising:
determining, after the two rendering images to be rendered are respectively moved in the corresponding visible regions, first areas respectively corresponding to two visible areas that cannot display the rendering images; and
displaying in the first areas corresponding to the two visible areas according to a preset display format.

18. The non-transitory computer-readable storage medium according to claim 17, the method further comprising:
determining, after that the two rendering images to be rendered respectively move in the corresponding visible areas, actual output display areas respectively corresponding to the two visible areas that display the two rendering images to be rendered; and
according to the two rendering images to be rendered, respectively performing rendering operations in the actual output display areas of visible areas.
